(19) United States
(12) Patent Application Publication
(10) Pub. No.: US 2025/0201249 A1
(43) Pub. Date: Jun. 19, 2025

(54) INFORMATION PROCESSING DEVICE, INFORMATION PROCESSING METHOD, AND RECORDING MEDIUM

(71) Applicant: Sharp Kabushiki Kaisha, Sakai City (JP)

(72) Inventors: SATOSHI TERADA, Sakai City (JP); Akito Yoshimura, Sakai City (JP)

(21) Appl. No.: 18/975,056

(22) Filed: Dec. 10, 2024

(30) Foreign Application Priority Data
Dec. 15, 2023 (JP) 2023-212134

(51) Int. Cl. G10L 15/26; G06Q 10/10

(52) U.S. Cl. CPC G10L 15/26; G06Q 10/10

(57) ABSTRACT

An information processing device includes one or more processors, wherein the one or more processors: acquire speech information including speech data and an utterance time per utterance issued by a plurality of participants of a meeting; convert the speech data into character data; acquire operation information including operation content and an operation time per operation performed by the plurality of participants; and generate minutes data based on the speech information, the character data, and the operation information.

### CROSS-REFERENCE TO RELATED APPLICATION

The present application claims priority from Japanese Application JP 2023-212134, the content to which is hereby incorporated by reference into this application.

### BACKGROUND OF THE INVENTION

### 1. Field of the Invention

The disclosure relates to an information processing device and an information processing method.

### 2. Description of the Related Art

In a known browsing system, identification information of an utterer and text data of a speech recognition result are stored in association with each other per piece of time information of an utterance. On an utterance list screen of a series of speech recognition results, markers can be assigned to utterances, and an utterance can be searched for according to a specified search condition. Search results are displayed on a search screen.

### SUMMARY OF THE INVENTION

In the related art, even in a case that a meeting participant himself/herself performs an operation such as a note input on a terminal device or the like, the content of the operation is not reflected in contents of automatically generated minutes, and thus the contents of the minutes may not be accurate.

An object of the disclosure is to provide an information processing device and an information processing method in which accurate minutes data is generated based not only on character data converted from speech data for each utterance during a meeting but also on the content of an operation performed on a terminal device by a participant.

According to the disclosure, an information processing device includes one or more processors. The one or more processors acquire speech information including speech data and an utterance time per utterance issued by a plurality of participants of a meeting, convert the speech data into character data, acquire operation information including operation content and an operation time per operation performed by the plurality of participants, and generate minutes data based on the speech information, the character data, and the operation information.

According to the disclosure, an information processing method is a computer-implemented information processing method including acquiring speech information including speech data and an utterance time per utterance issued by a plurality of participants of a meeting, converting the speech data into character data, acquiring operation information including operation content and an operation time per operation performed by the plurality of participants, and generating minutes data based on the speech information, the character data, and the operation information.

According to the disclosure, the minutes data is generated based not only on the character data converted from the speech data for each utterance during the meeting but also on the content of the operation performed on the terminal device by the participant. As a result, the content of the operation by the participant is appropriately reflected, enabling minutes to be more accurately generated.

### BRIEF DESCRIPTION OF THE DRAWINGS

FIG. 1 is a block diagram illustrating a configuration of a minutes generating system including an information processing device 100 according to a first embodiment of the disclosure.

FIG. 2 is a time chart illustrating a temporal relationship between utterances X and operations Y by each participant P.

FIG. 3 is an explanatory diagram illustrating an operation in which the participant P creates minutes, a note, and the like of the participant P on the terminal device 10.

FIG. 4 is an explanatory diagram illustrating an example in which operation input and the like on the terminal device 10 are reflected in the minutes generated by the information processing device 100.

FIG. 5 is an explanatory diagram illustrating an example in which main points and a summary are displayed together with the minutes.

FIG. 6 is a flowchart illustrating an information processing method by the information processing device 100.

FIG. 7 is an explanatory diagram illustrating an example in which operation inputs and the like from a plurality of terminal devices 10 are reflected in the minutes generated by a minutes generating system 1A according to a second embodiment of the disclosure.

### DETAILED DESCRIPTION OF THE INVENTION

Embodiments of the disclosure will be described below with reference to the drawings. Note that, in the drawings, the same or equivalent components are denoted by the same reference numerals and signs, and description thereof will not be repeated.

### First Embodiment

### 1.1 Overall Configuration of Minutes Generating System 1

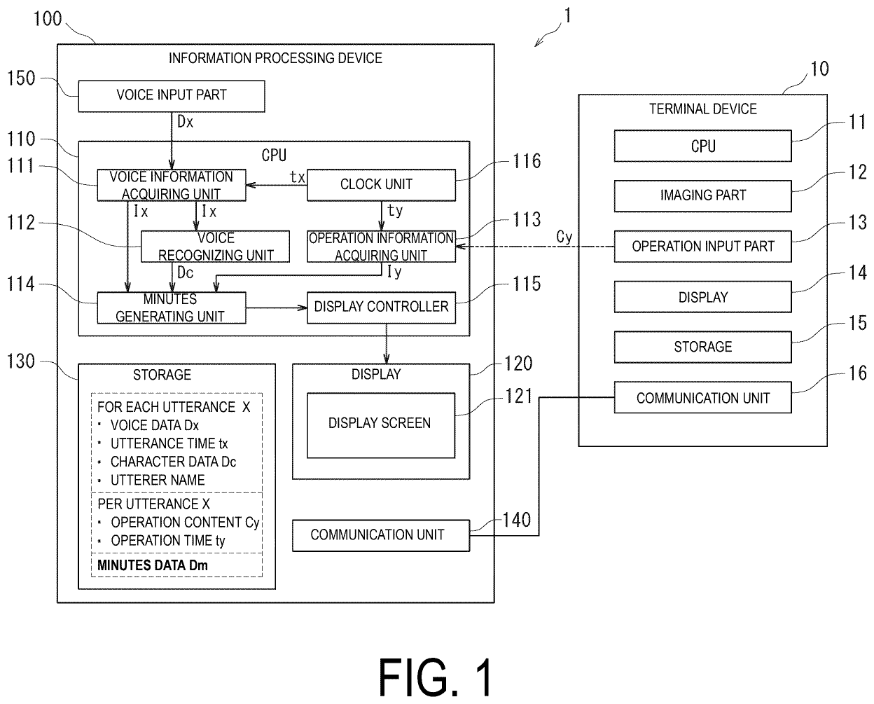

First, an overall configuration of a minutes generating system 1 including an information processing device 100 that automatically generates minutes of a meeting will be described with reference to FIG. 1. FIG. 1 is a block diagram illustrating the configuration of the minutes generating system 1 including the information processing device 100 according to the first embodiment of the disclosure.

As illustrated in FIG. 1, the minutes generating system 1 includes an information processing device 100 and a terminal device 10. The terminal device 10 is a device operated by a participant P to create minutes, a note, and the like of the participant during or before or after the meeting. The terminal device 10 is connected to the information processing device 100 via a network in a wired or wireless manner, but the connection method is not limited to network connection. For example, the terminal device 10 may be directly connected to the information processing device 100 using a USB cable, a dedicated cable, or a wireless connection method such as Bluetooth (registered trademark).

### 1.2 Configuration of Information Processing Device 100

The information processing device 100 includes a Central Processing Unit (CPU) 110, a display 120 including a display screen 121, a storage 130, a communication unit 140, and a speech input part 150.

The speech input part 150 receives a sound of an utterance X issued by each participant P and outputs speech data Dx to a speech information acquiring unit 111. The speech input part 150 may output, to the speech information acquiring unit 111, not only directly input speech but also, for example, speech data transmitted from the outside via a network and received by the communication unit 140.

The speech input part 150 includes, but is not limited to, for example, a microphone. The speech input part 150 may be built in the information processing device 100. The speech input part 150 may be a wired or wireless hand microphone, or a microphone of a wireless headset. Two or more of these may be used in combination. In a case that a wireless headset is connected to the terminal device 10, speech data from the microphone is received by the information processing device 100 via a communication unit 16 and the communication unit 140, and transmitted to the speech input part 150. However, the wireless headset may be directly connected to the information processing device 100 wirelessly. In a case that a plurality of wireless headsets are used, each participant P uses a different wireless headset, and thus utterances X of a plurality of participants P are not mixed in one piece of speech data. This facilitates identification of the utterer of the speech data.

The CPU 110 controls each unit of the information processing device 100. The CPU 110 includes the speech information acquiring unit 111, a speech recognizing unit 112, an operation information acquiring unit 113, a minutes generating unit 114, a display controller 115, and a clock unit 116.

The CPU 110 may be, for example, one or more processors, one or more Micro Processing Units (MPUs), and one or more control devices/arithmetic devices, but is not limited thereto. For example, given the storage 130 stores an Operating System (OS. The operating system may also be referred to as “basic software”) operating in the CPU 110 and programs for functions corresponding to the respective units described above, the CPU 110 perform the OS and the programs to embody the units. Examples of the OS include, but are not limited to, Microsoft Windows (registered trademark), Android (registered trademark), and Linux (registered trademark). Each of the above units may include, but is not limited to, one or more electronic circuits, a Digital Signal Processor (DSP), a Field Programmable Gate Array (FPGA), an Application Specific Integrated Circuit (ASIC), or the like.

The clock unit 116 includes a clock function, and outputs at least hour, minute, and second data at that point in time. The clock unit 116 may further include a calendar function and can output year, month, and day data.

The speech information acquiring unit 111 acquires speech information Ix including speech data Dx and an utterance time tx for each of the utterances X issued by the plurality of participants P of the meeting. The speech information acquiring unit 111 acquires the speech data Dx from the speech input part 150 and acquires the utterance time tx from the clock unit 116. For example, in a case that each participant P uses an individual wireless headset or the like and thus the utterer of each piece of speech data Dx is known in advance, the speech information Ix may include an utterer name.

The speech recognizing unit 112 converts the speech data Dx into character data Dc. Examples of speech recognition include, but are not limited to, an existing technology in which Artificial Intelligence (AI) analyzes a word uttered by a human being or a conversation between human beings and converts the word or the conversation into text data.

The operation information acquiring unit 113 acquires operation information Iy including operation content Cy and an operation time ty per operation Y performed by the participant P. Examples of the operation content Cy include an input of a character, a symbol, or the like, a specific operation, and the like. For example, the input of a character, a symbol, or the like includes, but is not limited to, an input of a predetermined character string related to the progress of a meeting, or an input of a special symbol (for example, ? or ⋆). The specific operation or the like includes, but is not limited to, a click operation, a double click operation, a tap operation, and the like.

The minutes generating unit 114 generates minutes data Dm based on the speech information Ix, the character data Dc, and the operation information Iy.

Therefore, the minutes data is generated based not only on the character data Dc converted from the speech data Dx for each utterance X during the meeting but also on the operation content of an operation such as note input performed by the participant P. As a result, the operation content Cy of the operation by the participant P is appropriately reflected, enabling minutes to be more accurately generated. Note that the minutes data Dm includes, but is not limited to, for example, the content or summary of each utterance X (so-called “transcription”), and an excerpt of the utterance content.

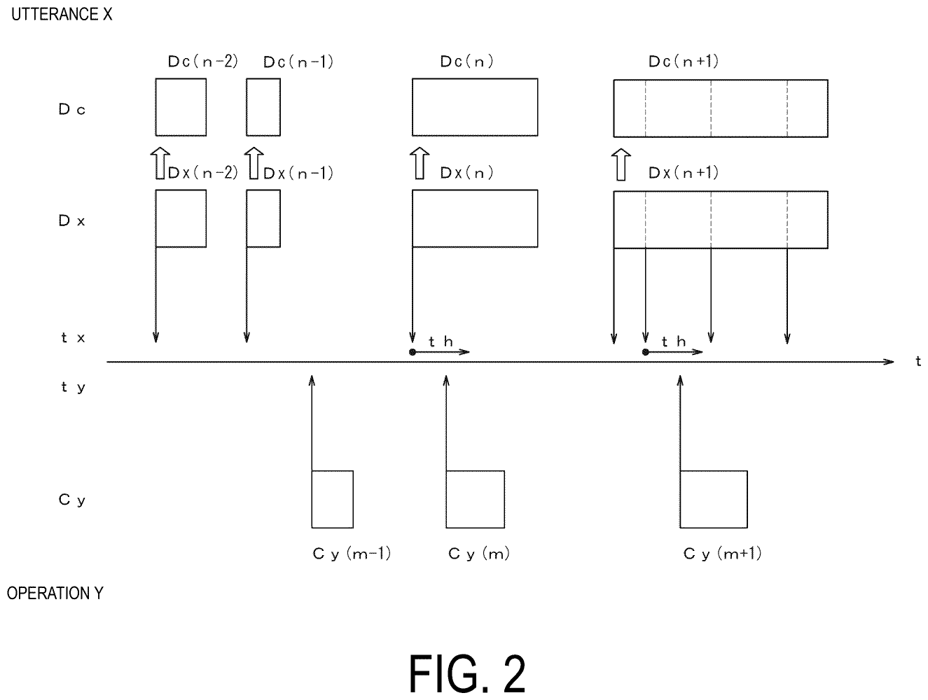

The minutes generating unit 114 may generate the minutes data Dm by regarding the operation content Cy corresponding to the operation time ty included in a predetermined proximity time tn determined per piece of character data Dc as corresponding to the character data Dc. The predetermined proximity time tn is a time from the utterance time tx corresponding to the character data Dc until a predetermined time has elapsed. The predetermined time is assumed to be, for example, several seconds to over ten seconds, but is not limited to such a time. Further, in a case that the operation content Cy includes character input data, the character data is approximate to the input data, and thus the corresponding character data Dc may be identified. The corresponding character data Dc can be more accurately identified by combination with the approximation determination based on the input characters. Note that the predetermined proximity time tn will be described later with reference to FIG. 2.

Therefore, the minutes data Dm is generated by reflecting, in the character data Dc converted from the speech data Dx for each utterance X, the operation content Cy likely to actually correspond to the character data Dc. As a result, the minutes can be generated more accurately.

The display 120 displays the character data Dc. As will be described later, the operation content Cy may be visibly displayed. Further, the display 120 may display the minutes data Dm generated at regular intervals. As a result, the operation content Cy and how the minutes data Dm is created can be visually checked.

The display 120 may or may not include a memory function. Examples of the display including no memory function include, but are not limited to, liquid crystal and Organic Electro-Luminescence (EL). Examples of the display including a memory function include, but are not limited to, electronic paper.

The display controller 115 may display the character data Dc and the operation information Iy on the display 120. Therefore, the display 120 displays the character data Dc converted from the speech data Dx and the operation information Iy including the operation content Cy and the operation time ty. As a result, what type of operation is performed for what kind of utterance X can be visually checked.

The storage 130 stores the speech data Dx in association with the utterance time tx, and stores the operation content Cy in association with the operation time ty. Therefore, the speech data Dx for each utterance X is stored in association with the utterance time tx, and the operation content Cy is stored in association with the operation time ty. As a result, the minutes data Dm can be generated not only during the meeting but also after the meeting has ended.

The storage 130 also stores information and data necessary for controlling each unit of the information processing device 100. The storage 130 may store or save an OS, programs, and the like executed by the CPU 110. The storage 130 includes a memory, specifically, a volatile memory and a nonvolatile memory. Examples of the volatile memory include, but are not limited to, a Dynamic Random Access Memory (DRAM) and a Static Random Access Memory (SRAM). Examples of the nonvolatile memory include, but are not limited to, a Read-Only Memory (ROM), a flash memory, a Solid State Drive (SSD), and a hard disk.

The communication unit 140 is connected to the communication unit 16 of the terminal device 10 in a wired or wireless manner. As a result, the terminal device 10 and the information processing device 100 can communicate bidirectionally.

### 1.3 Temporal Relationship Between Utterance X and Operation Y by Each Participant P

Next, an example of determining whether the utterance X and the operation Y by each participant P are temporally proximate to each other will be described with reference to FIG. 2. FIG. 2 is a time chart illustrating a temporal relationship between the utterances X and the operations Y by each participant P.

As illustrated in FIG. 2, the speech data Dx for each utterance X in the order of the utterance time tx is assumed to be managed with a serial number or time information attached to the speech data Dx. For example, the n-th speech data Dx is represented as “Dx(n)”. Each piece of speech data Dx is illustrated as a rectangle, and the width of the rectangle corresponds to the duration of each utterance X. The left end of the rectangle corresponds to the start time of the utterance X, and the right end of the rectangle corresponds to the end time of the utterance X.

Here, the utterance time tx corresponds to the start time of each utterance X (the left end of the rectangle), but is not limited to such correspondence. The utterance time tx may be, for example, an intermediate time between the start time and the end time.

Each piece of speech data Dx is provided with the character data Dc obtained by conversion by the speech recognizing unit 112. Like the speech data Dx, the character data Dc is also managed with a serial number or time information attached to the character data Dc. The n-th speech data Dx(n) corresponds to the n-th character data Dc(n).

On the other hand, the operation content Cy of the operation performed by the participant P during the meeting is similarly managed with a serial number or time information attached to the operation content Cy. For example, the m-th operation content Cy is represented as “Co(m)” here.

As described above, the minutes generating unit 114 regards the operation content Cy corresponding to the operation time ty included in the predetermined proximity time tn determined for each character data Dc as corresponding to the character data Dc. For example, under the character data Dc(n) in the upper center of FIG. 2, a range of the predetermined proximity time tn is illustrated immediately above a time axis t. The predetermined proximity time tn includes the operation time ty of the operation content Cy(m). Thus, the minutes generating unit 114 regards the operation content Cy(m) as corresponding to the character data Dc(n).

That is, the minutes generating unit 114 determines that the operation content Cy(m) is temporally proximate to the n-th utterance X. This means that the operation content Cy(m) is likely to correspond to the n-th utterance X.

However, for example, when the duration is long as in the (n+1)-th utterance X, it may be difficult to accurately determine which part of the utterance X is temporally proximate to any operation Y. Preferably, for example, the utterance X in such a case is divided per sentence in the utterance X and the parts obtained by the division are separately dealt with. For example, in a case that the (n+1)-th utterance X is divided into four parts, which are separately dealt with, the second part can be determined to be temporally proximate to operation content Cy(m+1).

### 1.4 Configuration of Terminal Device 10

As described above, the terminal device 10 is a device operated by the participant P to create minutes, a note, and the like of the participant P during or before or after the meeting. Examples of the terminal device 10 include, but are not limited to, a notebook computer, a smartphone, and a tablet.

As illustrated in FIG. 1, the terminal device 10 includes a CPU 11, an imaging part 12, an operation input part 13, a display 14, a storage 15, and a communication unit 16. This hardware configuration is the same as that of a general notebook computer, a smartphone, a tablet, or the like, and thus a detailed description thereof will be omitted.

The imaging part 12 interprets the face of the participant P who is operating the terminal device 10. The participants P can be distinguished from each other by recognition of a face image. The imaging part 12 may be, but is not limited to, for example, a built-in camera.

The operation input part 13 receives an operation input from the user. Examples of the operation input part 13 include, but are not limited to, a button, a keyboard, and a touch panel that enables a touch operation.

Examples of the display 14 include, but are not limited to, liquid crystal and organic electro-luminescence (EL). The display 14 may be a touch panel, and may also be used as the operation input part 13.

### 1.5 Examples of Display of Minutes by Information Processing Device 100

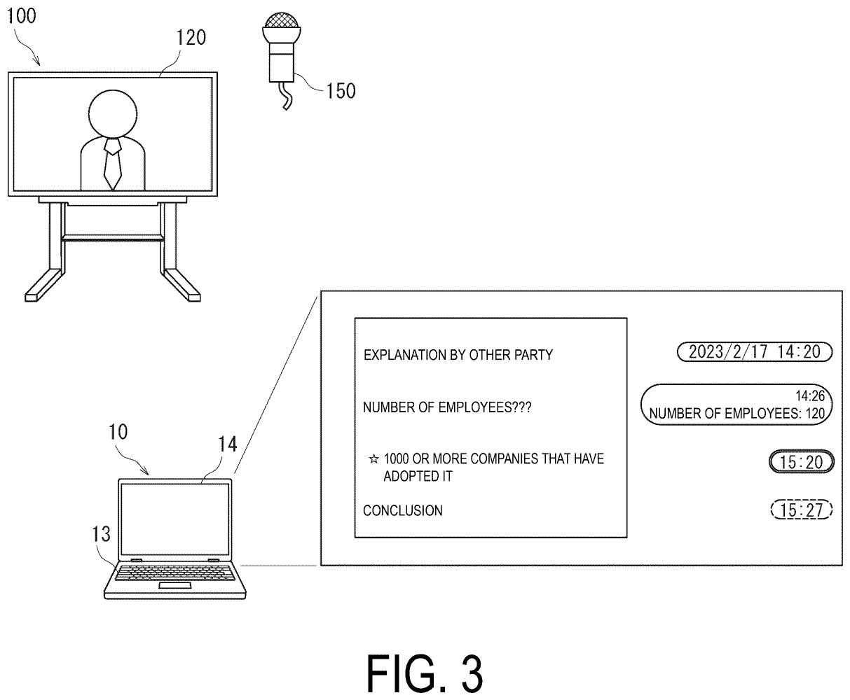

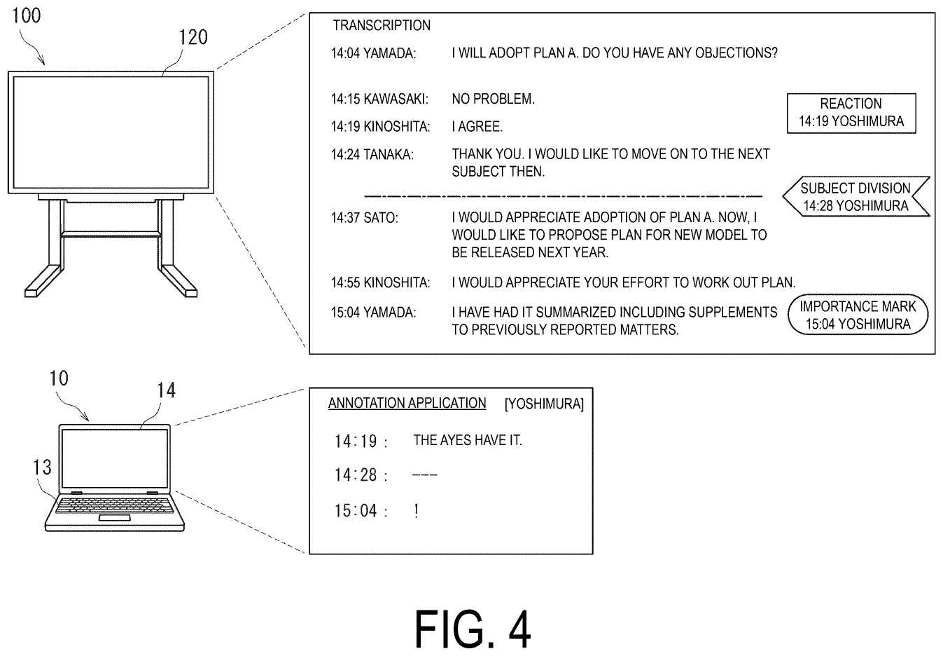

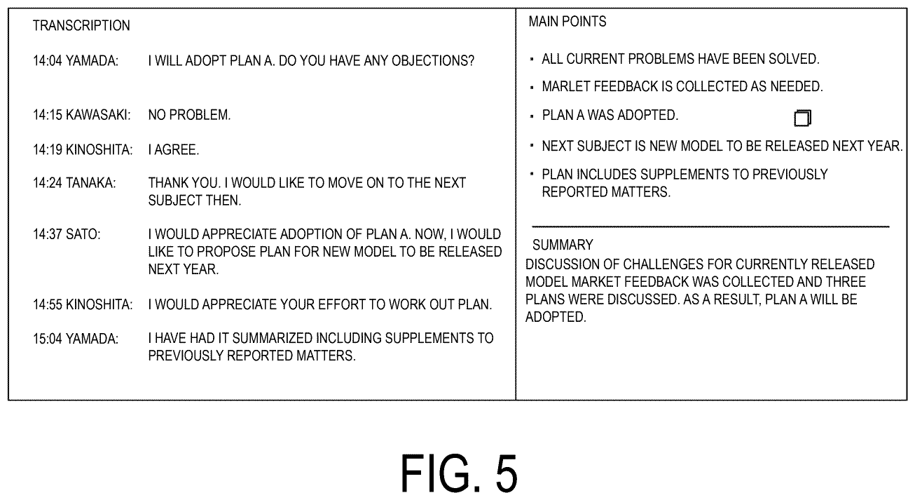

Next, examples of display of minutes by the information processing device 100 will be described with reference to FIGS. 3 to 5. FIG. 3 is an explanatory diagram illustrating an operation in which the participant P creates minutes, a note, and the like of the participant P on the terminal device 10. FIG. 4 is an explanatory diagram illustrating an example in which operation input and the like in the terminal device 10 are reflected in minutes generated by the information processing device 100. FIG. 5 is an explanatory diagram illustrating an example in which main points and a summary are displayed together with the minutes.

### 1.5.1 Examples of Display on Terminal Device 10

As illustrated in FIG. 3, in a case that the participant P performs an operation such as character input through the operation input part 13 in the terminal device 10 connected to the information processing device 100, input content is displayed on the display 14, and additional display by the information processing device 100 is also performed. Note that the operation content Cy of each operation on the terminal device 10 is stored in the storage 130 in association with the operation time ty.

For example, inputting a simple sentence such as “Description by the other party” causes the simple sentence to be displayed on the display 14. The operation time ty is displayed right-aligned in the same row as that in which the simple sentence is displayed.

For example, at a part that the participant P cannot hear, inputting a special symbol such as “the number of employees???” (in this case, “?”) causes the content of the minutes to be supplemented based on the character data Dc, with “the number of employees is 120” displayed, if possible.

In a case that “⋆” is preset as a symbol for designating an important part, and for example, “⋆1000 or more implementing companies” is input, the operation time ty is highlighted. Examples of the highlighting include, but are not limited to, display in a more eye-catching color or in bold.

For example, by providing an input including a character string related to the progress of the meeting such as “conclusion”, separation between subjects is recorded at a position corresponding to the operation time ty. The display 120 may display the manner of separating the subjects or the like in a way in which the manner can be explicitly indicated to the user, or the manner may be reflected instead of being displayed in a case that the minutes generating unit 114 generates minutes.

### 1.5.2 Example of Display on Information Processing Device 100

As illustrated in FIG. 4, the display 120 of the information processing device 100 displays the character data Dc. Specifically, for example, each transcribed utterance X is chronologically displayed along with the utterance time tx and the utterer name.

For the utterance X for which the operation Y is present that is determined to be temporally proximate to the utterance X, the operation content Cy of the operation Y is displayed in the same row in a right-aligned manner. The operation time ty and the operator name may be displayed together with the operation content Cy. For example, the utterance X of Kawasaki at 14:15 is displayed in such a manner that a reaction made at 14:19 by Yoshimura, who is a participant P, can be realized at a glance. This display does not indicate the content of the reaction, but may be replaced with display that allows the content to be known. Note that an application (annotation application) suitable for the disclosure is activated on the terminal device 10 used by Yoshimura, and the display 14 indicates that Yoshimura input “The ayes have it.” at 14:19. Note that the display position and the display method are not limited to those described above.

In a case that the operation content Cy includes an input of a character string C related to the progress of the meeting, the minutes generating unit 114 may separate the minutes data Dm for each subject at a position corresponding to the character string C. Therefore, in a case that the operation content Cy of the participant P includes the input of the character string C related to the progress of the meeting, the minutes data Dm is separated for each subject at the position corresponding to the character string. As a result, the minutes data Dm is accurately separated for each subject.

The display 120 of the information processing device 100 indicates that Tanaka said “Thank you. I would like to move on to the next subject.” at 14:24. In response to the utterance X, the display 14 of the terminal device 10 indicates that Yoshimura input “----” at 14:28. Here, “-” or continuous “-” is a part of character string related to the progress of the meeting. Thus, the minutes generating unit 114 may separate the minutes data Dm at a position corresponding to “----”. A separation line may be displayed at the separation position. In addition, a character string “topic division” may be displayed together with the operation time ty and the operator name on the same row as the separation line. Note that the display position and the display method are not limited to those described above.

In a case that the operation content Cy includes a predetermined operation or an input of a predetermined symbol, the minutes generating unit 114 may generate the minutes data Dm corresponding to the operation content Cy as an important part. Therefore, when the operation content Cy includes a predetermined operation or an input of a predetermined symbol, a part corresponding to the predetermined operation is determined as an important part. As a result, the important part in the minutes data Dm is accurately distinguished.

The display 120 of the information processing device 100 indicates that Yamada said “I have had it summarized including supplements to the previously reported matters” at 15:04. The display 14 of the terminal device 10 indicates that, in response to this utterance X, Yoshimura input “!” at 15:04. Here, “!” is a symbol indicating an important part of the meeting. Thus, the minutes generating unit 114 may generate the minutes data Dm using, as an important part, a part corresponding to “!”. A mark or the like indicating importance may be displayed in the same row as that of the utterance X indicated as an important part, together with the operation time ty and the operator name. Specifically, the mark may be displayed in a more eye-catching color or in reverse video. Note that the display position and the display method are not limited to those described above.

### 1.5.3 Another Example of Display on Information Processing Device 100

As illustrated in FIG. 5, the information processing device 100 may display main points and a summary together with the character data Dc. For example, it is assumed that the display screen 121 of the display 120 is divided into a left side and a right side, and the right side is further divided into an upper side and a lower side. In this case, transcribed utterances X may be displayed on the left side, extracted main points may be displayed on the upper right side, and a summary may be displayed on the lower right side. Note that the display position and the display method are not limited to those described above.

Based on the important part, the minutes generating unit 114 may extract main points from the generated minutes data Dm and generate a summary of the minutes data Dm. Therefore, not only the minutes data Dm is generated, but also main points are extracted and a summary is generated based on the part considered to be important by the participant P. As a result, more accurate main points and summary can be obtained.

Note that the main points and the summary may be collectively generated as minutes after the meeting, but may be generated or corrected in real time in accordance with the progress of the utterances X of the participants P and the operation Y from the terminal device 10, or in accordance with the quantity of utterances or elapsed time after the beginning of the meeting, the timing of separation between the subjects, or the like to update the display content of the display screen 121.

### 1.6 Information Processing Method for Generating Minutes by Information Processing Device 100

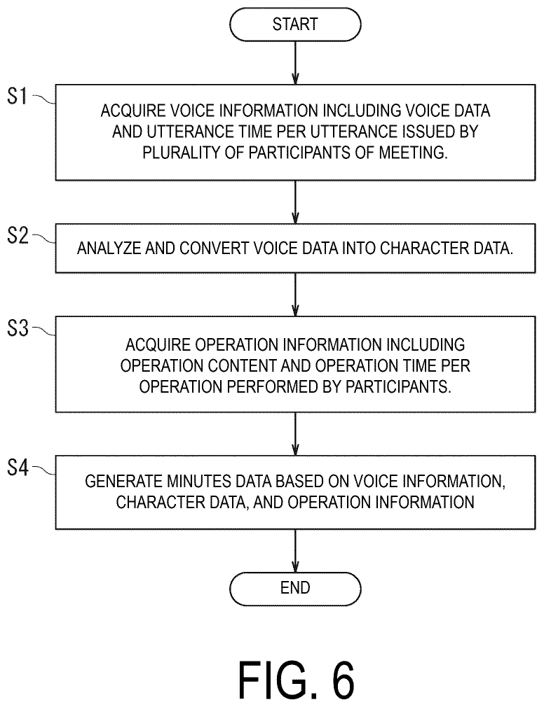

Next, an outline of an information processing method for generating minutes by the information processing device 100 will be described with reference to FIG. 6. FIG. 6 is a flowchart illustrating an information processing method by the information processing device 100.

As illustrated in FIG. 6, first, in step S1, the speech information acquiring unit 111 acquires the speech information Ix including the speech data Dx and the utterance time tx for each of the utterances X issued by the plurality of participants P of the meeting. Note that step S1 is an example of a “speech information acquiring step” of the disclosure.

In step S2, the speech recognizing unit 112 analyzes the speech data Dx and converts the speech data Dx into the character data Dc. Note that step S2 is an example of a “speech recognizing step” of the disclosure.

In step S3, the operation information acquiring unit 113 acquires the operation information Iy including the operation content Cy and the operation time ty for each of the operations Y performed by the participants P. Note that step S3 is an example of an “operation information acquiring step” of the disclosure.

Finally, in step S4, the minutes generating unit 114 generates the minutes data Dm based on the speech information Ix, the character data Dc, and the operation information Iy, and then terminates the series of processing operations. Note that step S4 is an example of a “minutes generating step” of the disclosure.

Therefore, the minutes data is generated based not only on the speech recognition result (character data Dc) obtained by analyzing the speech data Dx for each utterance X during the meeting but also on the operation content Cy such as a note input performed by the participant P. As a result, the operation content Cy of the operation by the participant P is appropriately reflected, enabling minutes to be more accurately generated.

### Second Embodiment

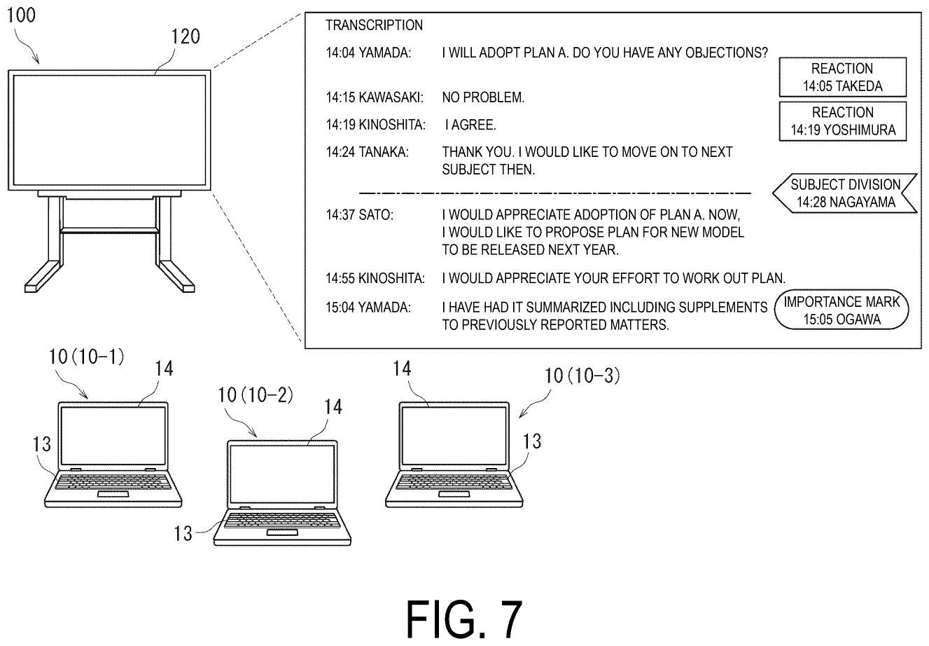

Next, a case where the plurality of participants P perform operation inputs and the like on the respective terminal devices 10 will be described with reference to FIG. 7. FIG. 7 is an explanatory diagram illustrating an example in which operation inputs and the like from the plurality of terminal devices 10 are reflected in the minutes generated by the minutes generating system 1A according to the second embodiment of the disclosure.

As illustrated in FIG. 7, the minutes generating system 1A includes the information processing device 100 and the terminal devices 10. Note that the information processing device 100 and each terminal device 10 basically have the same configuration as in the first embodiment. In a case that each of the terminal devices 10 needs to be individually identified, reference numerals such as 10-1, 10-2, and 10-3 are used. Hereinafter, differences from the first embodiment will be mainly described.

In a case that the operation information acquiring unit 113 acquires the operation information Iy including the operation content Cy from the plurality of participants P, the minutes generating unit 114 may regard a part of the minutes data Dm corresponding to the operation content Cy from the plurality of participants P as an important part. Therefore, the input operations from the plurality of participants P causes the part of the minutes data Dm corresponding to the operation contents Cy of the input operations to be regarded as an important part in the minutes data Dm. As a result, the important part in the minutes data is more accurately distinguished.

On the display 120 of the information processing device 100, each transcribed utterance X is chronologically displayed together with the utterance time tx and the utterer name, and the operation content Cy is also displayed, as in the case of the display illustrated in FIG. 4.

In response to the utterance of Yamada “I will adopt plan A. Do you have any objections?” at 14:04, Kawasaki issued an utterance at 14:15, and Kinoshita issued an utterance at 14:19. As seen in the minutes, in spite of the lack of utterances, Takeda made a reaction at 14:05, and Yoshimura made a reaction at 14:19. The minutes clearly indicates how and why, in response to the utterances and reactions described above, Tanaka determined that agreement had been obtained from the participants P, and said “Thank you. I would like to move on to the next subject then.” at 14:24.

The occurrence of a plurality of reactions to a specific utterance X indicates that the utterance X can be determined to be likely to correspond to an important part. Note that, for a small number of participants P, the utterance can be determined to be likely to correspond to an important part simply due to the occurrence of a plurality of reactions but that this is not the case with a large number of participants P. For example, a threshold for the number of persons may be provided, and the utterance may be determined to be likely to correspond to an important part only in a case that the number of reacting persons exceeds the threshold. In addition, for example, the weight of the determination may be changed according to the role, the post, or the like of the participant P. For example, while the number of rank-and-file employees is limited to five or more, an utterance of even one official may be determined to be highly likely to correspond to an important part. Regarding the role, the post, or the like of the participant P, for example, the role, the post, or the like, or the weight of the determination may be stored in the storage 130 in association with the participant name.

The disclosure may be embodied in other various forms without departing from the spirit or essential characteristics of the disclosure. Thus, the above embodiments are merely examples in all respects and should not be interpreted as limiting. The scope of the disclosure is indicated by the claims and is not limited to the description. Furthermore, all modifications and changes within the range of equivalency of the claims are included in the scope of the disclosure.

### INDUSTRIAL APPLICABILITY

The disclosure can be utilized for an information processing device, an information processing method, and the like.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing device comprising one or more processors, wherein
the one or more processors:
acquire speech information including speech data and an utterance time per utterance issued by a plurality of participants of a meeting;
convert the speech data into character data;
acquire operation information including operation content and an operation time per operation performed by the plurality of participants; and
generate minutes data based on the speech information, the character data, and the operation information.

2. The information processing device according to claim 1, wherein
the one or more processors regard the operation content corresponding to the operation time included in a predetermined proximity time determined for the character data as corresponding to the character data, and generate the minutes data, and
the predetermined proximity time is a time from the utterance time corresponding to the character data until a predetermined time has elapsed.

3. The information processing device according to claim 1, further comprising: a display that displays the minutes data.

4. The information processing device according to claim 3, wherein the one or more processors cause the display to display the character data and the operation information.

5. The information processing device according to claim 1, further comprising a storage that stores the speech data in association with the utterance time and stores the operation content in association with the operation time.

6. The information processing device according to claim 1, wherein in a case that the operation content includes an input of a character string related to progress of a meeting, the one or more processors separate the minutes data into subjects at a position corresponding to the character string.

7. The information processing device according to claim 1, wherein in a case that the operation content includes an input of a predetermined operation or a predetermined symbol, the one or more processors generate the minutes data by using, as an important part, a part corresponding to the operation content.

8. The information processing device according to claim 1, wherein in a case of acquiring, from the plurality of participants, the operation information including the operation content, the one or more processors regard a part of the minutes data corresponding to the operation content from each of the plurality of participants as an important part.

9. The information processing device according to claim 7, wherein the one or more processors extract main points from the generated minutes data and generates a summary of the minutes data, based on the important part.

10. A computer-implemented information processing method, comprising:
acquiring speech information including speech data and an utterance time per utterance issued by a plurality of participants of a meeting;
converting the speech data into character data;
acquiring operation information including operation content and an operation time per operation performed by the plurality of participants; and
generating minutes data based on the speech information, the character data, and the operation information.

11. A non-transitory computer-readable recording medium storing a program for causing a computer to perform processing of:
acquiring speech information including speech data and an utterance time per utterance issued by a plurality of participants of a meeting;
converting the speech data into character data;
acquiring operation information including operation content and an operation time per operation performed by the plurality of participants; and
generating minutes data based on the voice information, the character data, and the operation information.
